(19) United States
(12) Patent Application Publication
(10) Pub. No.: US 2008/0137266 A1
(43) Pub. Date: Jun. 12, 2008

(54) Motor control center with power and data distribution bus

(75) Inventors: David L. Jensen, Barneveld, WI (US); David D. Brandt, New Berlin, WI (US)

Correspondence Address: ROCKWELL AUTOMATION, INC./(FY), ATTENTION: SUSAN M. DONAHUE, E-7F19, 1201 SOUTH SECOND STREET, MILWAUKEE, WI, 53204, US

(73) Assignee: Rockwell Automation Technologies, Inc.

(21) Appl. No.: 11/540,380

(22) Filed: Sep. 29, 2006

(51) Int. Cl. H02B 5/00

(52) U.S. Cl. 361/602; 710/316; 307/125

(57) ABSTRACT

A motor control center (MCC) is provided. The MCC includes a power and data distribution bus comprising a plurality of conductive bars for distributing power and data signals within the MCC. In one embodiment, the plurality of conductive bars is configured to receive and distribute three-phase power from an external power source. The MCC may also include a device configured to receive power and data from the plurality of conductive bars. Devices and methods for distributing power and data to such devices within an MCC are also disclosed.

### BACKGROUND

The present technique generally relates to power and data distribution within a motor control center (MCC). More particularly, the present technique relates to distribution of both power and data signals over a common power and data distribution bus.

In a number of applications, networked systems require distribution of both power and data signals to and from any number of devices. For example, in industrial applications, a networked system may distribute power, typically three-phase power, as well as appropriate data signals to any number of locations and devices. In traditional systems, power and data signals are transmitted over discrete wiring pathways. That is, power is distributed over dedicated power wires and data is distributed over dedicated data wires, both of which are disposed in separate protective conduits or cable jackets tubing.

As will be appreciated, an MCC may house a number of components of the industrial system, generally providing a centralized location for controlling and providing power to loads in a regulated manner. Such components generally include switching and protection devices. In a typical MCC, the components are networked to each other via numerous wires, resulting in crowded wire passages within the MCC, and increased installation and maintenance costs. Other MCCs have been developed that include smart components that are configured to communicate over a network cable instead of numerous discrete wires, but such MCCs still generally require the network cables to be routed through the same wire passages. Further, these network cables are often used to daisy-chain units to one another, preventing removal of a unit without first disconnecting the network cables, and further adding to installation and maintenance costs of the system.

In still another type of MCC, an integral network bus may be provided to permit communication to the devices and the system. In this arrangement, a device or unit could be plugged into the integral MCC network bus with a short cable, thus avoiding the labor associated with installing and uninstalling hand wired daisy-chain cables. However, this design generally requires installation of a discrete communication network within the MCC, and the application of low voltage dc power to operate the communication network. Still further, such a network may impose certain hurdles on component design and selection to meet constraints of such a topology, including consideration of trunk length, drop budget, terminations, and data rate selections, to name but a few, which also impact manufacturing and servicing costs.

There is a need, therefore, for an improved MCC system that provides efficient communication between devices in the MCC and reduces manufacturing and maintenance costs for the system.

### BRIEF DESCRIPTION

The present invention generally provides techniques for configuring an MCC and associated components to respond to the needs briefly outlined above. Particularly, the MCC utilizes a combined power and data distribution bus system comprising a plurality of conductive bus bars. The MCC and components are configured to concurrently transmit both power and data over the same conductive bus bars, thus avoiding the need for separate power distribution and data transmission systems. In one embodiment, the combined bus system concurrently transmits data signals and one phase of three-phase power over the same conductive path. In another embodiment, data signals are provided with auxiliary control power delivered by common auxiliary bus bars.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram of an exemplary power and data distribution system having a number of components in accordance with one embodiment of the present invention;

FIG. 2 is a front elevational view of an exemplary MCC for housing various devices of a control system in accordance with one embodiment of the present invention;

FIG. 3 is an additional front view of the MCC of FIG. 2 with the various devices removed to illustrate a power and data distribution bus of the MCC in accordance with one embodiment of the present invention;

FIG. 4 is a front elevational view of the power and data distribution bus of FIG. 3 in accordance with one embodiment of the present invention;

FIG. 5 is a diagram of the MCC and various devices illustrated in FIGS. 2-4, and generally depicts the distribution and routing of power and data through the power and data distribution bus to the devices within the MCC in accordance with one embodiment of the present invention;

FIG. 6 is a diagram of various components of an exemplary motor controller adapted to communicate over the power and data distribution bus in accordance with one embodiment of the present invention; and

FIG. 7 is a diagram of various components of an additional motor controller also adapted to communicate over the power and data distribution bus in accordance with one embodiment of the present invention.

### DETAILED DESCRIPTION

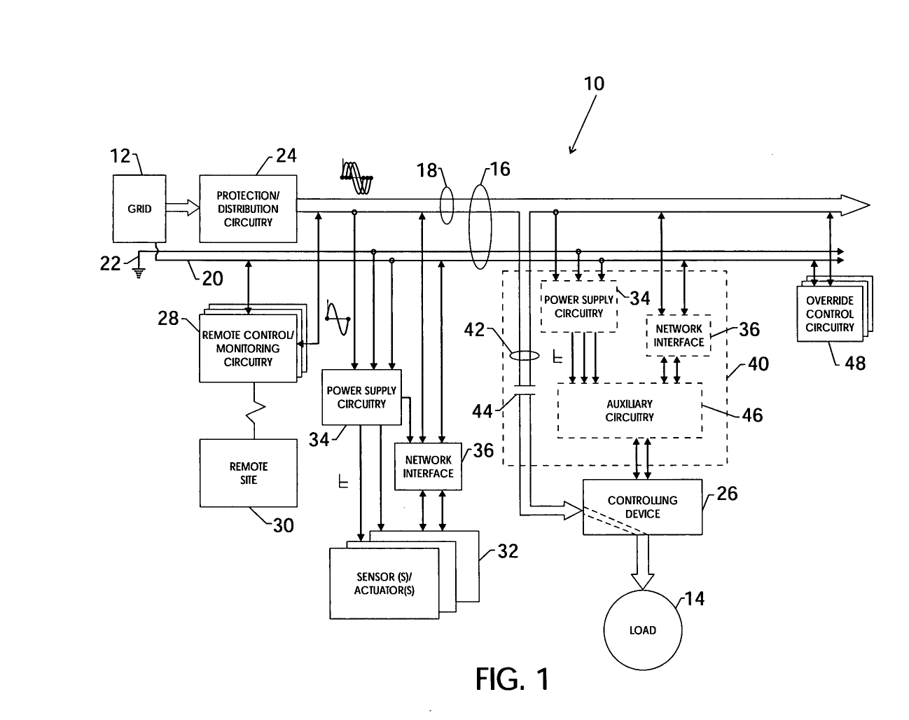

In industrial applications, efficient distribution of power and data signals is often a motivating concern. Referring to FIG. 1, an exemplary section of a power and data distribution system 10 is presented. Although, for the purposes of explanation, the present embodiment relates to an industrial application, the present technique can be applied to any number of settings in which the efficient distribution of power and data is a concern. Returning to the present embodiment, the power and data distribution system 10 comprises a three-phase power source 12, such as a generator or power grid. The three-phase power may be ac power, such as 480V power, that powers a load 14. For example, the load 14 may be a motor that operates on three-phase 480Vac power. For the present purposes, any voltage or current rating of ac power may be accommodated. Moreover, the power source 12 may be configured to provide other levels and kinds of power, such as 24Vdc, along with the primary three-phase power.

To achieve efficient operation, it may be advantageous for the load 14 to operate in response to, and in cooperation with, other system conditions. That is, the load 14 may be more efficient if operated in light of, for example, the status or condition of other motors, sensors, controllers, or any other components disposed throughout the system 10. Accordingly, the system 10 facilitates the transmission of data signals to and from these various components. While these various components may be distributed remotely from one another in certain embodiments, in an exemplary embodiment discussed in greater detail below a number of these components are disposed within an MCC.

In the exemplary system 10, three-phase power and the data signals may be transmitted and communicated over a plurality of conductors 16. More particularly, three-phase power may be respectively conducted on power conductors 18. As further discussed below, data signals may be transmitted throughout the system 10 over a neutral conductor 20 and one of the power conductors 18. To conduct power and data signals concurrently over a power conductor, the data signals may be transmitted in accordance with a data communications protocol. As discussed below, in the context of a localized control center such as an MCC, power and data may be distributed throughout the MCC over internal bus bars. Additionally, for protection of the system 10, as well as to comply with commonly accepted design standards, the system 10 may comprise an earth ground conductor 22 that provides a path to earth ground.

To protect the system 10 against power surges, protection circuitry 24 may be disposed electrically downstream of the power source 12 and upstream of all or a large portion of the remainder of the network. However, it should be noted that the protection circuitry 24 may also be placed electrically proximate to the load or component it protects. Moreover, the protection circuitry 24 may even be integrated into the network component itself. Simply put, the protection circuitry 24 may be distributed and decentralized with respect to the networked system. The protection circuitry 24 may comprise, for example, circuit breakers, as well as switches and fuses, each designed to prevent inappropriate power levels from reaching the remainder of the power and data distribution system 10 as well as the particular network component. Moreover, the protection circuitry 24 may be configured to facilitate remote triggering and resetting thereof.

Coupled to the conductors 16 and located electrically between the load 14 and source 12 may be a controlling device 26, such as a relay, motor controller or motor starter. The controlling device 26, in response to an appropriate data signal, may interrupt three-phase power to the load 14. As discussed above, a decision to interrupt power to the load 14 may be based on monitored conditions of the system 10. Thus, the system 10 will typically include a number of sensors and circuits disposed throughout the system.

Advantageously, data collected by these circuits or sensors may be transmitted to a central location, such as remote control and monitoring circuitry 28, which may be disposed within an MCC. Remote control and monitoring circuitry 28 may function as a receiving and processing center for any number of data signals. Additionally, the monitoring circuitry 28 may generate appropriate response signals for various components in the system 10. In other words, the remote control and monitoring circuitry 28 may act as a brain for the system 10. It should be understood, however, that circuitry 28 may include one or more individual controllers, computers, and so forth, in a single or remote locations. Moreover, it should be understood that the control circuitry 28 may be distributed throughout the system. That is, the control circuitry 28 may be electrically positioned proximate to the various network components. Indeed, the control circuitry 28 may even be integrated into the network components themselves. In such embodiments, the network would not necessarily contain a “central control”, but rather an entire collection of remote control and monitoring circuits 28 working in tandem with one another.

In operation, the remote control and monitoring circuitry 28 may receive data signals from throughout the power and data distribution system 10. It is worth repeating, however, that the monitoring and control circuitry 28 may be distributed and decentralized throughout the network. As further discussed below, these data signals may be transmitted over various conductors, such as over one of the power conductors 18 and a neutral conductor 20 working in cooperation with one another (e.g., via a differential signal protocol) in one embodiment. Accordingly, the exemplary remote control circuitry 28 is coupled to the neutral conductor 20, as well as to the appropriate power conductor 18.

Coupled to the remote control and monitoring circuitry 28 may be a remote site 30. The remote site 30 may provide a location for a network administrator or operator to view the signals received by the control and monitoring circuitry 28, determine the status of system 10, perform control functions, and so forth. Moreover, the remote site 30 may provide a mechanism through which the operator may remotely and manually control various individual or sets of components or operations of the networked system 10.

The remote control and monitoring circuitry 28 may, for example, receive data signals from sensors or actuators 32 disposed throughout the system 10. To operate, the sensors and actuators 32, and the various controlling devices 26 may require a level of power different than the exemplary 480Vac power. For example, the sensors and actuators 32 may require a level of power such as 120V single-phase ac or 24Vdc. Accordingly, power supply circuitry 34 may be disposed electrically between the power source 12 and the sensors and actuators 32. Advantageously, the exemplary power supply circuitry 34 is coupled to a power conductor 18, the neutral conductor 20 and the earth ground conductor 22. Thus, the power supply circuitry may receive a single phase of the three-phase power and appropriately convert this power to an operable power level. By way of example, the power supply circuitry 34 may rectify and transform the 120V single-phase ac power to a 24Vdc power. Additionally, the power supply circuitry 34 may be coupled to the ground conductor 22 so as to provide the power supply circuitry with a path to earth ground.

With appropriate power, the sensors and actuators 32 may receive and transmit data signals throughout the system 10. By way of example, the sensor may comprise a sensor indicative of the status or position of a machine component or workpiece. That is, the sensor 32 may be configured to indicate whether the component or workpiece is in an appropriate position to permit a programmer or manually controlled operation to proceed. Additionally, again by way of example, actuators may comprise any suitable devices, such as switches, relays, motors, control valves, pumps, hydraulic or pneumatic cylinders, and so forth.

The data obtained by the sensors 32 indicative of the condition of the actuators 32 may not be in a form that is interpretable by the remote control and monitoring circuitry 28. Accordingly, network interface circuitry 36 translates these signals into data signals that are more appropriate. That is, the network interface may translate the raw data into data signals in accordance with the predetermined data communications protocol. Such protocols may include common industrial protocols known in the art, such as the DeviceNet protocol, the ControlNet protocol, the ProfiBus protocol, EtherNet/IP, or the like. Additionally, the network interface circuitry 36 may translate return data signals from the remote control and monitoring circuitry 28 to the sensors or actuators 32. Again, to transmit the data signals, the network interface is electrically coupled to the appropriate power conductor, such as the power conductor 18 also carrying data signals, as well as the neutral conductor 20. In operation, the interface circuitry 36 translates the received data signals and sends response signals which, in turn, may instruct an actuator in its function.

Once these signals from the sensors and actuators 32 are received by the remote control and monitoring circuitry 28, they may be interpreted so as to determine the appropriate response signals for the controlling device 26, thereby controlling the load 14. The remote control and monitoring circuitry 28 may conduct, over the conductors 16, the appropriate data signals throughout the system 10. Coupled to the conductors 16, may be a power and data transfer assembly 40 which taps off of the conductors 16 and conducts the appropriate power and data signals to the controlling device 26 and, in turn, to the load 14. In the illustrated embodiment, a set of branch power conductors 42 conduct three-phase power through the power and data transfer assembly 40 and into controlling device 26. Coupled to these branch conductors may be a disconnect 44 configured to interrupt at least one phase of the three-phase power prior to the power reaching the controlling device 26, as described below. Advantageously, the disconnect facilitates power interruption to the load 14 upstream of the device 26, thereby allowing, if desired, one phase of power to reach the controlling device 26 or load 14. Additionally, the power and data transfer assembly 40 conducts network data signals to the controlling device 26, thereby controlling the load 14. That is, the transfer assembly 40 may receive data signals and, in turn, produce a signal which trips the controlling device 26, thereby interrupting power to the load 14.

Also, within the power and data transfer assembly 40 may be various types of auxiliary circuitry 46. The auxiliary circuitry may be configured to transmit signals indicative of the condition of the controlling device 26. For example, the auxiliary circuitry may produce a response signal if a relay is tripped, thereby confirming loss of power to the load 14. However, the auxiliary circuitry 46 may provide any number of functions to the power and data transfer assembly 40 as well as to the system 10. Indeed, the auxiliary circuitry 46 may be employed to present a secondary signal indicative of the status of any number of system conditions.

The auxiliary circuitry 46 may operate from power other than that provided by the main (e.g., 480V) ac three-phase power. Accordingly, power supply circuitry 34 may be employed to alter the power signal from the power conductors to a level more appropriate for the auxiliary circuitry 46. As discussed above, power supply circuitry 34 may be coupled to one of the power conductors, the neutral conductor 20, and an earth ground 22. The power supply circuitry 34 receives one phase of the three-phase power and converts this power to a power level more appropriate to the auxiliary circuitry 46. Again, by way of example, the power supply circuitry 34 may rectify and convert single-phase 120Vac power to 24Vdc power. Once appropriately conditioned or converted, the power supply circuitry provides sufficient power to the auxiliary circuitry 46 for operation. Additionally, the auxiliary circuitry 46 may then transmit this conditioned power, if appropriate, to the controlling device 26 for operation. However, if the controlling device 26 requires a power level different than that of the auxiliary circuitry 46, then the power supply circuitry 34 may be directly coupled to the controlling device 26 to provide an appropriate power level.

Similar to the sensors and actuators 32, the auxiliary circuitry 46 may not provide data signals interpretable by the remote control and monitoring circuitry 28 and vice-versa. Accordingly, network interface circuitry 36 may also be provided within the power and data transfer assembly 40. As discussed above, the network interface circuitry receives data signals from the auxiliary circuitry 46 and translates the signals into data signals comprehendible by the remote control and monitoring circuitry 28, that is, data signals in accordance with the data communications protocol in use. To conduct these appropriately translated data signals to the remote control and monitoring circuitry, the network interface circuitry 36 is coupled to the appropriate power conductor (i.e., the power conductor conducting both data and power) and a neutral conductor 20. It is again worth nothing that the remote control and monitoring circuitry 28 may be distributed throughout the network and may also be electrically proximate to the respective network components. Additionally, the network interface may receive data signals from the remote control and monitoring circuitry and translate such signals into signals appropriate for the auxiliary circuitry 46. In turn, the auxiliary circuitry may transmit the translated signals to the controlling device 26, thereby actuating the controlling device 26 and interrupting power to the load 14. It is worth noting, however, that the network interface, if so desired, may bypass the auxiliary circuitry 46 and couple directly to the controlling device 26. Indeed, if so desired, the controlling device may bypass the assembly 40 and be directly coupled to the conductors 16.

In many instances, it may be necessary to interrupt power to the load in response to an override condition occurring in the system 10. Accordingly, the system 10 may include override control circuitry 48. The override circuitry 48 receives data signals from the network and determines, in accordance with an override protocol, whether an override signal is to be transmitted. If so, then the override circuitry produces this signal in accordance with both the override protocol as well as the data communications protocol, thereby interrupting power to the load 14. The override circuitry 48 may be centralized in a central control configuration, such as the MCC discussed in detail below, or distributed throughout the system. For example, override circuitry 48 may be integrated into the components of the network. Indeed, the override circuitry 48 may be integrated into a given network component and configured to terminate power to the component in response to a detected override condition within the component. Simply put, the component may terminate power to itself. Moreover, the override circuitry 48 within a component may be capable of sending a signal that terminates operation and power to the entire system. Depending on the nature and origin of the interrupt command, any number of override protocols may be executed.

For the purposes of explanation, the networked system or power and data distribution system 10 may implement a simple press operation. In this explanatory example, the load 14 may be viewed as a motor configured to drive a press plunger in a reciprocating manner. The exemplary press, more particularly the motor of the press, may be powered by three-phase 480Vac power. Coupled between the power source and the press motor may be a controlling device 26, such as a motor controller or contactor. When open, the contactor would prevent three-phase power from reaching the motor, thereby disabling the press. However, the contactor may operate based upon logic to determine when, and for what duration, power to the motor should or should not be applied.

Accordingly, the various sensors 32 throughout the system may provide data, once translated by network interface circuitry 36, to the remote control and monitoring circuitry 28 which, in turn, analyzes this data and produces a return data signal indicative of what the desired contactor status should be. This signal may then be transmitted over the appropriate power conductor 18 (i.e., the conductor that conducts both the data signals and one phase of the ac power) and the neutral 20 to the power and data transfer assembly 40. Such communication may be provided in accordance with a safety protocol, such as a lockout/tagout protocol to avoid unexpected energization of various components and machinery during servicing of such components and machinery. Once received by the assembly 40, the network interface circuitry 36 disposed therein may then translate this signal to one which is more appropriately understood by either the auxiliary circuitry 46 or the controlling device 26. This signal would then instruct the controlling device (i.e., the contactor) to either maintain power to the motor or to interrupt power in response to a system condition.

Additionally, and continuing the instant example, the override circuitry 48 may produce response signals so as to prevent the motor (i.e., load 14) from operating because of a certain condition of the system 10. By way of example, a sensor 32 may be coupled to a press door or guard and configured to indicate whether this guard is either in an opened or closed position. The sensor 32 would then be scanned periodically, or, alternatively, when the door is open, the sensor would then transmit an indicative signal to the network interface which would in turn translate the signal to one appropriate for the remote control and monitoring circuitry 28. If the signal is related to an override event, the signal is transmitted to override control circuitry 48 or to both that circuitry and the remote control monitoring circuitry 28. The override circuitry interprets the signals and determines, in accordance with an override or safety protocol, that the press guard is open and, as such, the motor should not be operable. The override circuitry would then create a data signal, in accordance with a predetermined override protocol, and transmit this newly created data signal, over the appropriate conductors, to the power and data transfer assembly 40. Once received, the power and data transfer assembly, by way of the network interface circuitry 36, appropriately instructs the controlling device to discontinue control power to the contactor and, as such, prevent operation of the motor until the sensor indicates that the door is closed. Advantageously, the override circuitry 48 may thus function in parallel with the control circuitry, and may transmit coordinated signals in its own protocol over the same conductors.

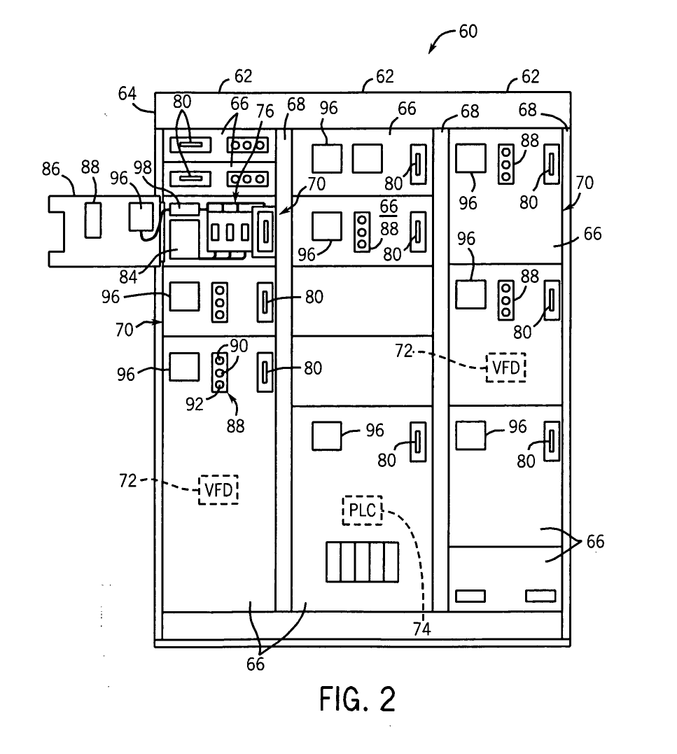

As discussed above, various components of the system 10, in addition to other components, may be disposed within an MCC. An exemplary MCC containing such components is illustrated in FIG. 2. In a typical factory setting, one or more such MCC installations may be made to control a large number of material handling, manufacturing, packaging, processing, and other equipment, such as the reciprocating press plunger noted above. In the illustrated embodiment, the MCC comprises three sections 62. However, a greater or lesser number of sections 62 may be used. The MCC 60 receives three-phase ac line power and couples it to each section 62. In the illustrated embodiment, each section 62 has an enclosure 64 that is adapted to couple power to a plurality of units or “buckets” 66. In the illustrated embodiments, the units 66 are adapted to “plug-in” to the MCC 60. However, other methods of coupling the units 66 to the MCC, and other devices, may be used. The units 66, in turn, are adapted to be disposed into the enclosures 64 to receive power. The units 66 may also receive non-hazardous power from a low-voltage (e.g., 24 Vdc) power source. In addition, the units 66 may receive and transmit data via a pre-established data protocol, such as a common industrial protocol. As discussed in greater detail below, the MCC 60 is configured to facilitate communications between the units 66 while reducing or avoiding the need for discrete communication wiring or cabling between the units 66. However, in this embodiment, each section 62 has a wireway 68 for routing any such supplemental communication wiring that may be desired.

In the illustrated embodiment, the various units 66 comprise several motor controllers 70, which may be similar to controlling device 26 (FIG. 1), which are plugged into the MCC 60 to receive power. The motor controllers 70 are adapted to selectively control power to one or more electric motors. In this embodiment, the motor controllers 70 receive three-phase ac power from the MCC over a plurality of internal bus bars, as discussed at length below, and output power to a load, such as load 14. Alternatively, a motor controller 70 may provide ac power to a variable frequency drive 72 to enable the variable frequency drive 72 to produce a variable frequency ac to power one or more electric motors. The variable frequency ac power may be coupled from each variable frequency drive 72 to a motor via a motor controller 70. In the illustrated embodiment, a programmable logic controller (PLC) 74 is provided to enable one or more devices to be controlled automatically either from the PLC or via the communications network.

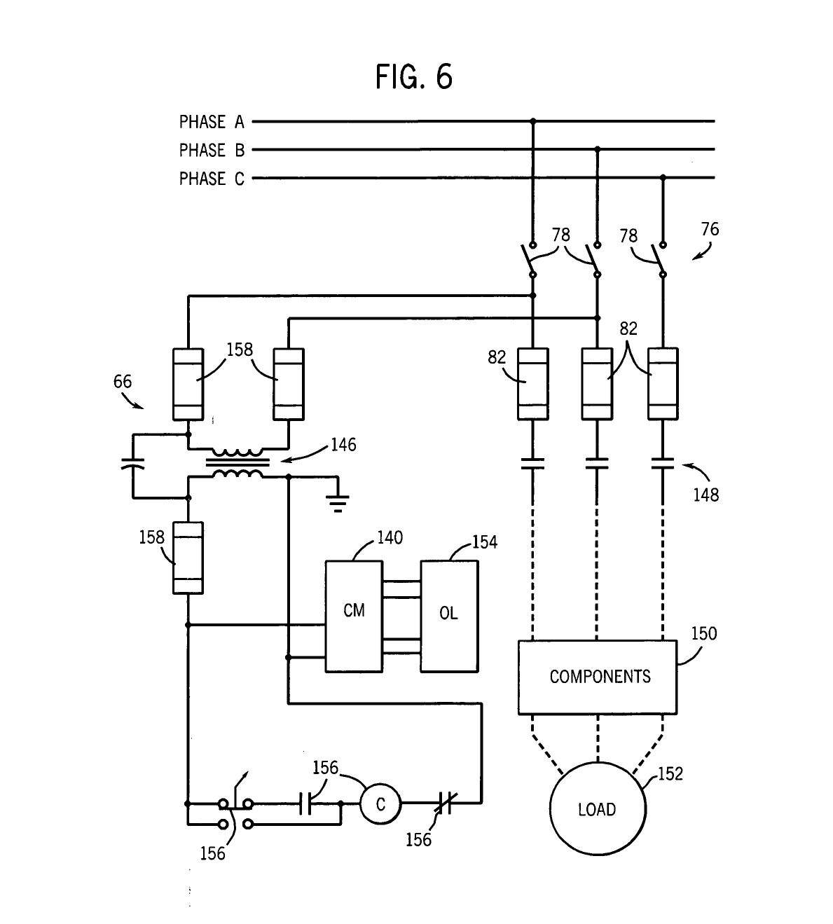

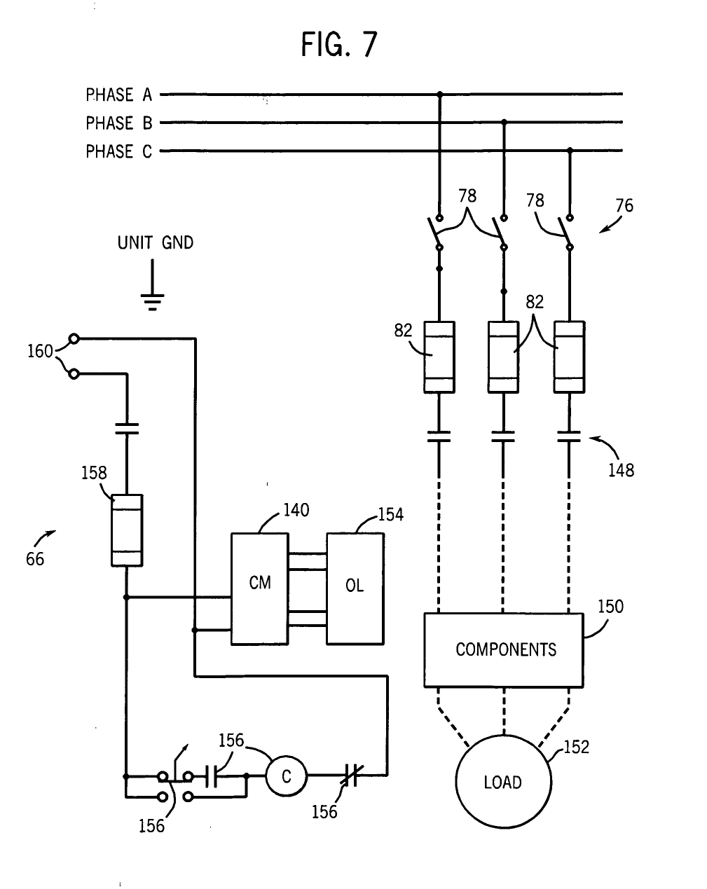

The units 66 may include a disconnect 76 that is provided to electrically isolate the respective unit 66 from the MCC. In one embodiment, with particular reference to the motor controller 70 having its interior exposed in FIG. 2, the disconnect 76 of the motor controller is adapted with three switches 78 (FIGS. 6 and 7), one for each phase of the three-phase alternating current. Each disconnect 76 may have a handle 80 disposed on the exterior of the unit 66 that is operable to open and close the switches 78. In addition, the disconnect 76 may be adapted to house a short-circuit protection device. In the illustrated embodiment, the short-circuit protection device may comprise three fuses 82, one for each phase of the three-phase alternating current, as illustrated in greater detail in FIGS. 6 and 7. However, other short-circuit protection devices, such as circuit breakers, may be used instead or in addition to the fuses and switches. In the illustrated embodiment, the three-phase power is coupled to additional electrical components 84 within the unit 66.

Each of the exemplary units 66 has a door 86 to enable the interior of each unit 66 to be accessed. In addition, some units 66 have a control station 88. In the illustrated embodiment, the control station 88 has various indicator lights 90, which may provide an indication of the operating status of a unit 66, the existence of an overload condition or some other fault condition, or the like. A control switch 92 is provided to control operation of the unit 66. The units 66 may also include other diagnostic systems 98 that enable an operator to assess the status or operating conditions of the units 66 without having to open the door 86. As illustrated in the present embodiment, such systems 98 may include an indicator or display 96 that is visible from the exterior of the unit 66 with the door 86 closed. In one embodiment, the display may signal whether voltage is present the various conductors of the MCC.

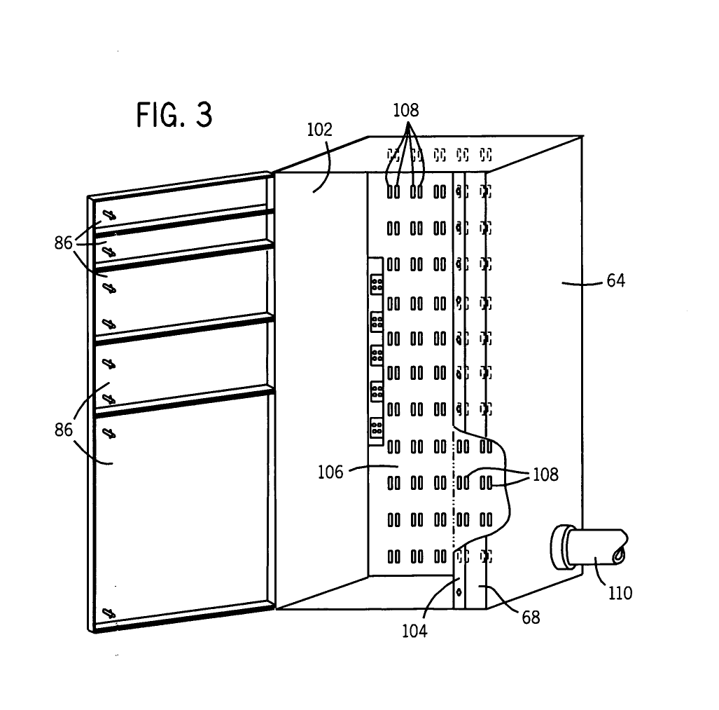

Additional features of an individual exemplary enclosure 64 are illustrated in FIG. 3. For the sake of clarity, the presently illustrated enclosure 64 is provided without the various units 66 to facilitate explanation of certain features of the enclosure. In general, the enclosure 64 generally defines a device mounting volume 102 for receiving various units 66. As will be appreciated, the enclosure 64 may be made of any suitable material, such as heavy gage sheet metal, reinforced plastics, or the like. As discussed above, although the present techniques provide for communication within the enclosure without the need for discrete wiring between units 66 installed within the enclosure, the enclosure 64 may include a wireway 68 in which additional load wiring, cabling, and so forth may be installed to service the components within the device mounting volume 102. Individual doors 86 are provided for covering individual compartments of the enclosure that may be subsequently defined by shelves (removed for the sake of clarity) or other structures that support the electrical components of units 66. A latch rail 104 is provided adjacent to the device mounting volume to interface with latches on the individual doors.

A communication and power bus subassembly 106 is provided along a rear wall of the enclosure 64. As described in greater detail below, the bus subassembly permits power and data to be distributed throughout the enclosure in a plug-in manner without the need for a discrete communication network. The bus subassembly 106 is generally formed as a backplane having slots 108 for receiving conventional stab-type electrical connections on rear surfaces of device or unit supports received within the enclosure. Such slot and stab arrangements are generally known in the art. In the illustrated embodiment, the slots 108 are divided in pairs to receive corresponding two-pronged stabs for each phase of electrical power. Rows of such slots are provided to allow device supports to be mounted at various levels within the enclosure. Electrical power and data signals are provided to the enclosure via one or more appropriate conduits, as indicated generally by reference numeral 110.

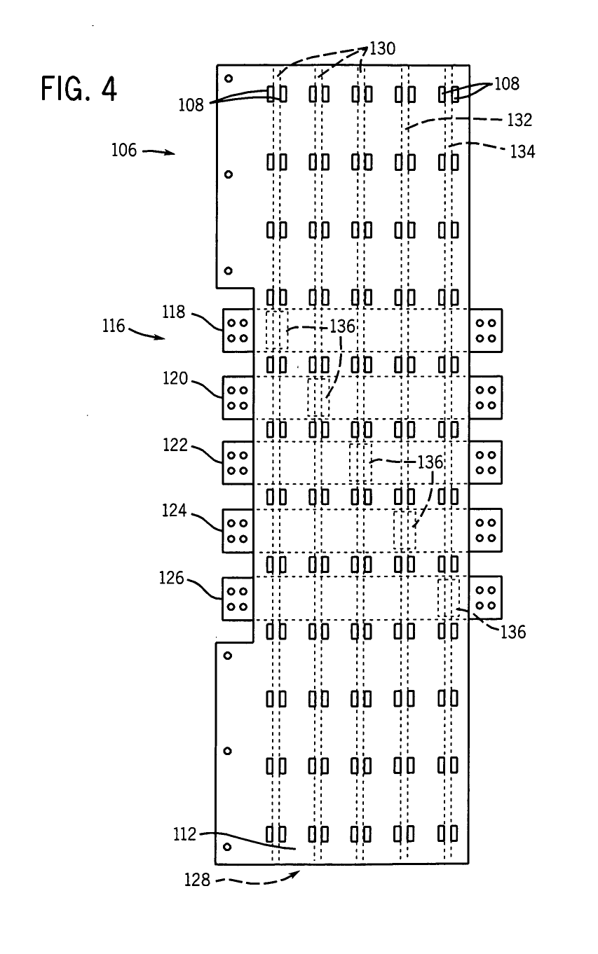

FIG. 4 illustrates the bus subassembly 106 removed from the enclosure 64 of FIG. 3 to clarify additional features of the subassembly. As shown in the elevational view of FIG. 4, the bus subassembly 106 generally includes a bus cover 112, which may be a molded sheet of synthetic material disposed over a series of horizontal and vertical busses. The bus cover serves to prevent contact between installed units 66 and the underlying busses except through slots 108.

More particularly, in the present embodiment, the bus subassembly 106 includes and supports a series of horizontal conductive busses 116 and vertical conductive busses 128, which are generally adapted to carry power and data to units 66 installed within the enclosure 64. In one embodiment, the horizontal busses receive three-phase power and a neutral connection from an external power supply, such as the grid or power supply 12 discussed above. In certain embodiments, including that illustrated, the horizontal busses 116 include horizontal conductive bus bars 118, 120, 122, 124, and 126, while the vertical busses 128 include several vertical conductive bus bars 130, in addition to vertical conductive bus bars 132 and 134. In one exemplary embodiment, the horizontal bus bars 118, 120, and 122 collectively provide three-phase power to the MCC, and to the installed units 66 via respective vertical bus bars 130, each of these horizontal and vertical bus bar pairs carrying a single phase of the three-phase power.

Additionally, in some embodiments, the horizontal bus bar 124 is coupled to the vertical bus bar 132 and serves as a neutral bus within the MCC. It should be noted, however, that the neutral bus bars 124 and 132 may be omitted in other embodiments in full accordance with the present techniques. Also, if desired, auxiliary line or control power may be distributed within the MCC through horizontal bus bar 126 and vertical bus bar 134. However, if such additional power is not desired, the horizontal bus bar 126, the vertical bus bar 134, and its respective slots 108 may also be omitted in accordance with the present techniques. In the presently illustrated embodiment, each horizontal bus bar is connected to its respective vertical bus bar at connection ports 136, and the horizontal and vertical bus bars are otherwise electrically isolated from one another.

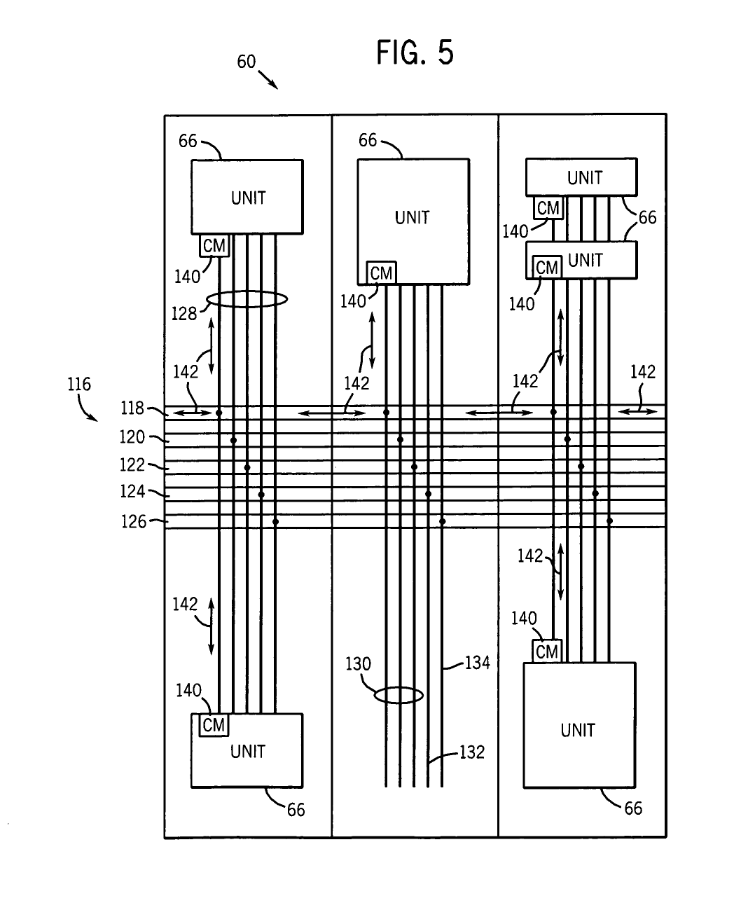

As noted above, and as illustrated in the exemplary embodiment of FIG. 5, the horizontal and conductive bus bars of busses 116 and 128 facilitate both power and data transmission to and/or from an installed unit 66 within the MCC 60. Particularly, installed units 66 may be electrically coupled to some or all of the vertical bus bars to receive power and to communicate data over the internal bus bars. In one embodiment, an installed unit 66 receives three-phase power from the horizontal power bus bars 118, 120, and 122 via the vertical bus bars 130.

In the illustrated embodiment, each unit 66 includes a communication module 140 coupled to the components of the unit 66 and adapted to receive and/or transmit communications or data signals over a power bus bar, such as one or more of the vertical bus bars 130. In short, the communication modules 140 enable the units 66 to communicate with each other or with other system components through the bus bars of busses 116 and 128. Advantageously, the communication or data signals may be provided in accordance with a data communications protocol that facilitates the transmission of power and data concurrently over a power conductor. For example, the data communications protocol may comprise a standard protocol adapted to provided data signals over power, such as a protocol known as HomePlug, or similar technologies. Further, as will be appreciated, a communication module 140 may be an internal component of the unit 66 or may be coupled to an exterior of the unit in full accordance with the present techniques.

In the illustrated embodiment, each of the communication modules 140 is also coupled to a single, respective vertical bus bar 130. In such an arrangement, data signals may be communicated to and from the installed units 66 over a combined power and data path comprising the horizontal bus bar 118 and those vertical bus bars 130 that are coupled to the bus bar 118, as generally indicated by arrows 142. In other words, the same conductive bars that provide one phase of the three-phase power to the units 66 may be employed to concurrently transmit data signals within the MCC. As will be appreciated, the concurrent transmission of data signals over the power bus bars provides significant advantages. For example, in one embodiment, the MCC does not contain a discrete communication network separate from the integrated power and data bus network composed of the various bus bars described herein, obviating the need for numerous network cables, connectors, terminators, and the like, and resulting in reduced cost and labor associated with the MCC 60. Further, because the data signals are carried along with the power in the MCC 60, there is no need to inject additional power, such as a low voltage DC, just for the purpose of transmitting data. Finally, the concurrent transmission of data over the power bus bars allows for a more efficient modular system which allows for simpler and more cost-effective connection of devices without the need for considering drop budget or terminator application.

Although shown coupled to particular bus bars 130, it will be appreciated that the communication modules may be coupled to any of the power bus bars 130 to enable data communication over any phase of the three-phase power. Indeed, in another embodiment, one or more of the communication modules may be coupled to multiple vertical bus bars 130 to allow data signals to be transmitted over multiple phases of the three-phase power. As may be appreciated, such communication may allow for increased communication bandwidth or provide redundancy of data signals. In certain embodiments, the units 66 and communication modules 140 may also be coupled to neutral bus bars 124 and 132. These neutral bus bars may cooperate with those bus bars carrying both power and data signals to facilitate data communication, such as in accordance with a differential signal protocol, for example. It may be appreciated, however, that data transmission may occur independent of the neutral bus bars in other embodiments. For instance, a single-ended data signal may be transmitted over one phase of the three-phase power in cooperation with a protective earth ground (such as conductor 22 of FIG. 1), a differential signal may be conducted over two phases of the three-phase power, or the like.

In those embodiments that communicate over one or more phases of the three-phase power, the auxiliary power bus bars 126 and 134 may be omitted. However, in other embodiments, the bus bars 126 and 134 may be provided to supply auxiliary power to the units 66, and may serve as an alternative or additional data path for communication within the MCC 60. For instance, in one embodiment, data signals are transmitted within the MCC 60 over the auxiliary power bus bars 126 and 134. It should be noted that such an arrangement may facilitate servicing of a unit 66 by separating communication and control power from main power to the unit. For example, the unit may be configured such that partial removal of the unit disconnects main power to the unit (via vertical bus bars 130), while remaining connected to vertical bus bars 132 and 134. In such a position, the unit 66 may retain control power and data communications over the bus bars 132 and 134. Again, in certain embodiments, the neutral bus bars 124 and 132 may cooperate with power transmission bus bars, such as auxiliary power bus bars 126 and 134, in accordance with a differential signal protocol. Also, data may be transmitted over the auxiliary bus bars 126 and 134 in addition to the three-phase power bus bars to allow for redundancy of both operational power and data communications.

In some embodiments, and as noted above, a safety protocol may be imposed on the communication over the internal bus bars of the MCC to control power delivery to an external load, such as load 152 (FIGS. 6 and 7). The safety protocol may include a lockout/tagout protocol, as also described above. Finally, the communication modules 140 of some embodiments may be coupled to one or more of the three-phase source power bus, the auxiliary control power bus, or the output load power bus to sense the presence of voltage on these conductors and provide an indication of such a presence to an operator, service technician, or the like.

Two exemplary units 66 of the MCC 60 are illustrated in FIGS. 6 and 7. In each of these exemplary embodiments, the units 66 comprise motor controllers, such as motor controller 70 described above. However, as also noted above, the units 66 may include any of a number of various components for providing a wide range of functionality. In each of these embodiments, the unit 66 includes a disconnect 76 having switches 78 and fuses 82 to control the flow of three-phase power to downstream components 150 and a load 152, although a circuit breaker may instead be employed in other embodiments.

In the embodiment illustrated in FIG. 6, the unit 66 may receive power from the power bus and transform this power to a lower operating power, such as 24 Vac or 120 Vac single-phase power, via a step-down transformer 146. In an alternative embodiment, such as that of FIG. 7, the unit 66 may receive power from inputs 160, such as from a separate terminal block. The unit includes the communication module 140 adapted to communicate over the power transmission bus bars, as described in detail above. Finally, to protect and/or control elements of the unit 66, the components 150, and the load 152, the unit 66 may also include a variety of protection and overload circuitry known in the art, such as a motor starter 148, an electronic overload module 154, various additional components 156, including a motor starter coil and PLC contacts, and fuses 158.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A motor control center (MCC) comprising:
an enclosure defining an interior volume;
a power and data distribution bus disposed within the enclosure, the power data and distribution bus comprising a plurality of conductive bus bars including first, second, and third conductive bus bars that are each configured to receive one respective phase of three-phase power from an external power source and distribute the respective phases within the MCC, the plurality of conductive bus bars configured to receive data signals and to transmit the data signals within the MCC; and
a device disposed within the interior volume, wherein the device is configured to receive at least one phase of three-phase power distributed by the first, second, and third conductive bus bars, and is configured to receive data signals from at least one conductive bus bar of the plurality of conductive bus bars.

2. The MCC of claim 1, comprising a fourth conductive bus bar of the plurality of conductive bus bars, wherein the fourth conductive bus bar is a neutral bus bar and the device is configured to receive the data signals from at least one of the first, second, or third conductive bus bars in cooperation with the fourth conductive bus bar.

3. The MCC of claim 2, wherein the device is configured to receive redundant data signals from more than one of the first, second, or third conductive bus bars in cooperation with the fourth conductive bus bar.

4. The MCC of claim 2, comprising a fifth conductive bus bar of the plurality of conductive bus bars, wherein the fifth conductive bus bar is an auxiliary power bus bar configured to distribute auxiliary power within the MCC and to the device.

5. The MCC of claim 4, wherein the device is configured to receive the data signals from the fifth conductive bus bar in cooperation with the fourth conductive bus bar.

6. The MCC of claim 5, wherein the device is configured to receive redundant data signals from the at least one of the first, second, or third conductive bus bars and the fifth conductive bus bar in cooperation with the fourth conductive bus bar.

7. The MCC of claim 1, wherein the device is configured to receive data signals in accordance with a common industrial protocol.

8. The MCC of claim 7, wherein the device is configured to receive data signals in accordance with a safety protocol in addition to the common industrial protocol.

9. The MCC of claim 8, wherein the device is configured to control output power delivery to a load in conformance with the safety protocol.

10. The MCC of claim 8, wherein the safety protocol includes a lockout/tagout protocol.

11. The MCC of claim 1, wherein the device is configured to detect voltage present on one or more of the conductive bus bars and/or a load power bus, and to indicate whether such voltage is present.

12. The MCC of claim 1, wherein the MCC does not include a discrete communication network configured to operately independently from power distribution to components within the MCC.

13. The MCC of claim 1, wherein the device is configured to receive single-ended data signals from one of the first, second, or third conductive bus bars.

14. The MCC of claim 13, wherein the device is configured to receive the single-ended data signals from only one of the first, second, or third conductive bus bars.

15. The MCC of claim 1, comprising an auxiliary control power conductive bar, wherein the device is configured to receive data signals from the auxiliary control power conductive bus bar.

16. A device configured for installation in a motor control center (MCC), the device comprising:
a plurality of electronic components configured to receive at least one phase of three-phase power from a common source power bus comprising a plurality of conductive power bus bars; and
a communication module coupled to the plurality of electronic components, wherein the communication module is configured to receive data signals from a first conductive power bus bar of the plurality of conductive power bus bars.

17. The device of claim 16, wherein the communication module is configured to receive data signals from the first conductive power bus bar in cooperation with a neutral bus bar.

18. The device of claim 16, wherein the communication module is configured to receive the data signals and one phase of the three-phase power from the first conductive power bus bar.

19. The device of claim 16, wherein the communication module is configured to receive the data signals and derive an auxiliary power signal from the first conductive power bus bar, the auxiliary power signal being independent of the three-phase power.

20. The device of claim 16, wherein the communication module is configured to receive redundant data signals over the first conductive power bus bar and a second conductive power bus bar.

21. The device of claim 16, wherein the device comprises a motor controller.

22. The device of claim 21, wherein the communication module is configured to receive data signals in accordance with a safety protocol and to control power to a motor in conformance with the safety protocol.

23. The device of claim 22, wherein the plurality of components include override circuitry configured to enable the communication module to control the power to the motor.

24. A method for distributing power and data to a device within a motor control center (MCC) having a plurality of power bus bars, the method comprising:
applying three-phase power to a common source power bus of the MCC, the common source power bus comprising first, second, and third power bus bars of the plurality of power bus bars such that each of the first, second, and third power bus bars conducts one phase of the three-phase power;
coupling the device to and receiving power from at least one of the first, second, and third power bus bars; and
transmitting data signals to and/or receiving data signals from the device via at least one power bus bar of the plurality of power bus bars.

25. The method of claim 24, wherein the at least one power bus bar comprises at least one of the first, second, or third power bus bars.

26. The method of claim 24, wherein the at least one power bus bar comprises a fourth power bus bar that conducts auxiliary power to the device.

27. The method of claim 26, comprising coupling the device to each of the first, second, and third power bus bars.

28. The method of claim 27, comprising interrupting power to the device from the first, second, and third power bus bars while maintaining electrical communication between the fourth power bus bar and a neutral bus bar to facilitate concurrent servicing of and communication with the device.

29. The method of claim 26, comprising transmitting redundant data signals over multiple power bus bars of the plurality of power bus bars.

30. The method of claim 26, wherein transmitting data signals is performed in accordance with a safety protocol.
